(19) United States
(12) Patent Application Publication
(10) Pub. No.: US 2026/0159066 A1
(43) Pub. Date: Jun. 11, 2026

(54) DEVICE AND METHOD FOR CONTROLLING HYBRID ELECTRIC VEHICLE

(71) Applicant: TOYOTA JIDOSHA KABUSHIKI KAISHA, Toyota-shi (JP)

(72) Inventors: Masafumi YAMAMOTO, Nagakute-shi (JP); Yuuki MAKINO, Aichi-gun (JP)

(73) Assignee: TOYOTA JIDOSHA KABUSHIKI KAISHA, Toyota-shi (JP)

(21) Appl. No.: 19/370,881

(22) Filed: Oct. 28, 2025

(30) Foreign Application Priority Data
Oct. 29, 2024 (JP) 2024-189944

(51) Int. Cl. B60W 20/14

(52) U.S. Cl. CPC B60W 20/14; B60W 2510/085; B60W 2710/244

(57) ABSTRACT

A hybrid electric vehicle includes an internal combustion engine fueled by hydrogen, a battery, and a first motor generator configured to motor the internal combustion engine with electric power supplied from the battery. Processing circuitry is configured to execute a determining process of determining whether a scavenging operation is required to motor the internal combustion engine in a state in which fuel injection to the internal combustion engine is stopped, and a restriction process of restricting reduction of electric power stored in the battery when the determining process determines that the scavenging operation is required.

### CROSS-REFERENCE TO RELATED APPLICATIONS

This application is based upon and claims the benefit of priority from JP2024-189944, filed on Oct. 29, 2024, the entire contents of which are incorporated herein by reference.

### BACKGROUND

### 1. Field

The following description relates to a device and method for controlling a hybrid electric vehicle.

### 2. Description of Related Art

JP2018-39347A discloses a hybrid vehicle that includes a motor supplied with electric power from a battery to drive an internal combustion engine. When the engine stops operating and specified conditions are met, the hybrid vehicle performs a scavenging operation. In the scavenging operation, the internal combustion engine is motored in a state in which fuel injection is stopped. The scavenging operation removes moisture from the combustion chambers. Since this avoids wetting of spark plugs, the startability of the engine will not be affected.

Electric power is used during motoring when the scavenging operation is performed. Thus, when the stored electric power is low, there may not be enough electric power to perform the scavenging operation sufficiently.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a control device for a hybrid electric vehicle, the hybrid electric vehicle including an internal combustion engine fueled by hydrogen, a battery, and an electric motor configured to motor the internal combustion engine with electric power supplied from the battery, includes processing circuitry configured to execute a determining process of determining whether a scavenging operation is required to motor the internal combustion engine in a state in which fuel injection to the internal combustion engine is stopped, and a restriction process of restricting reduction of electric power stored in the battery when the determining process determines that the scavenging operation is required more than when the restriction process is not executed.

In another general aspect, a method for controlling a hybrid electric vehicle, the hybrid vehicle including an internal combustion engine fueled by hydrogen, and a battery, and an electric motor configured to motor the internal combustion engine with electric power supplied from the battery, includes determining whether a scavenging operation is required, in which the scavenging operation motors the internal combustion engine in a state in which fuel injection to the internal combustion engine is stopped, and when determining that the scavenging operation is required, restricting reduction of electric power stored in the battery more than when not restricting reduction of the electric power stored in the battery.

Other features and aspects will be apparent from the following detailed description, the drawings, and the claims.

### BRIEF DESCRIPTION OF THE DRAWINGS

FIG. 1 is a schematic diagram illustrating the structure of a vehicle in one embodiment.

FIG. 2 is a diagram illustrating operating ranges for a hybrid electric vehicle driving mode and a battery electric vehicle driving mode.

FIG. 3 is a flowchart illustrating the procedures of a process executed by processing circuitry.

FIG. 4 is a graph illustrating the relationship between required electric power and a target state of charge.

FIG. 5 is a graph illustrating the relationship between the required electric power and regenerative torque.

FIG. 6 is a graph illustrating the relationship between the required electric power and the upper limit value for performing external power supplying.

FIG. 7 is a flowchart illustrating the procedures of a process executed by the processing circuitry.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

One embodiment of a control device of a hybrid electric vehicle (HEV) will now be described.

### Structure of Vehicle

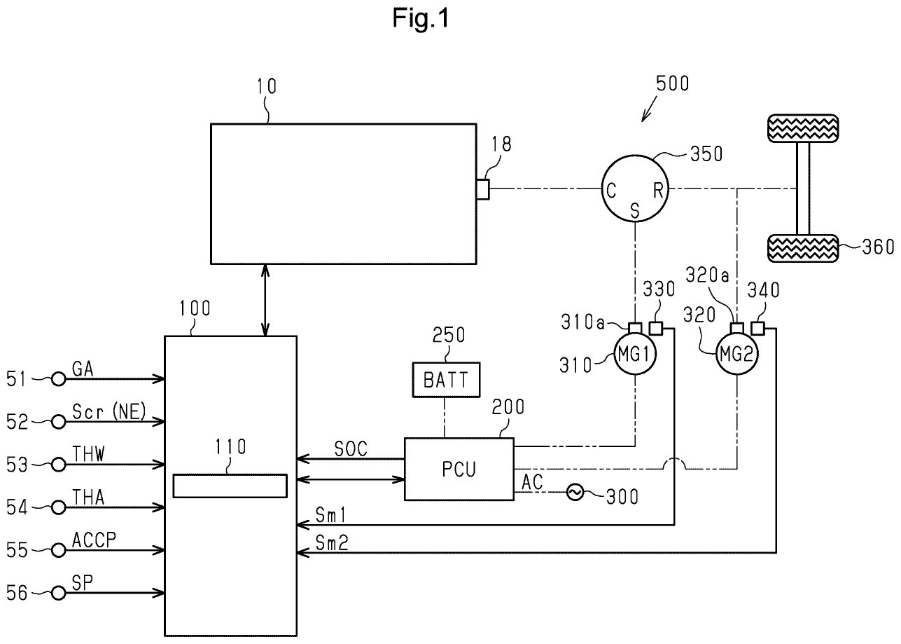

As shown in FIG. 1, a hybrid electric vehicle 500 includes an electric motor and an internal combustion engine 10 that act as power sources. In the description hereafter, the hybrid electric vehicle 500 will simply be referred to as the vehicle 500. The internal combustion engine 10 is fueled by hydrogen.

The internal combustion engine 10 includes a crankshaft 18 mechanically coupled to a carrier C of a planetary gear mechanism 350 that forms a power split mechanism.

A sun gear S of the planetary gear mechanism 350 is mechanically coupled to a rotational shaft 310a of a first motor generator (first MG) 310.

Further, a ring gear R of the planetary gear mechanism 350 is mechanically coupled to a rotational shaft 320a of a second motor generator (second MG) 320 and to drive wheels 360.

The first MG 310 functions as a power generator that generates electric power using the engine output and functions as a starter that cranks the crankshaft 18 to start the internal combustion engine 10. The first MG 310 is an electric motor that applies torque to the crankshaft 18 in order to motor the internal combustion engine 10.

The second MG 320 functions as an electric motor that generates driving force of the drive wheels 360 and functions as a power generator that generates electric power through a regenerative action when the vehicle 500 decelerates.

The first MG 310 and the second MG 320 receive electric power from and send electric power to a battery 250 via a power control unit (PCU) 200. The battery 250 is charged using the output of the internal combustion engine 10 and supplies electric power to the first MG 310 and the second MG 320. The PCU 200 includes a converter, which increases and outputs the direct voltage from the battery 250, and an inverter, which converts the direct voltage increased by the converter to alternating voltage and outputs the alternating voltage to the first MG 310 and the second MG 320. Further, the PCU 200 is connected to an external power supplying terminal 300 used to supply electric power from the battery 250 to equipment outside the vehicle. An example of external power supplying is the supply of electric power to power feeding equipment installed in a residence or a store.

### Control Device

A control device 100 controls the output and exhaust actions of the internal combustion engine 10 by controlling the intake air amount, the fuel injection amount, and the ignition timing. Further, the control device 100 operates the inverter via the PCU 200 to control the torque of the first MG 310. The control device 100 also operates the inverter via the PCU 200 to control the torque of the second MG 320.

The control device 100 includes processing circuitry 110. The processing circuitry 110 includes a central processing unit (CPU), which executes various processes in accordance with programs, and a read-only memory (ROM), which stores various programs.

The control device 100 refers to detection values from various sensors. For example, the control device 100 refers to a detection value from an air flow meter 51 that detects an intake air amount GA of the internal combustion engine 10. The control device 100 refers to a detection signal Scr from a crankshaft position sensor 52 that detects a rotation angle of the crankshaft 18. The control device 100 refers to a detection value from an engine coolant temperature sensor 53 that detects an engine coolant temperature THW of the internal combustion engine 10. The control device 100 refers to a detection value from an intake air temperature sensor 54 that detects an intake air temperature THA of the internal combustion engine 10. The control device 100 refers to a detection signal from an accelerator pedal position sensor 55 that detects an accelerator operation amount ACCP of the driver of the vehicle 500. The control device 100 refers to a detection signal from a speed sensor 56, which detects a vehicle speed SP of the vehicle 500. The control device 100 refers to an output signal Sm1 of a first rotation angle sensor 330, which detects a rotation angle of the first MG 310, and refers to an output signal Sm2 of a second rotation angle sensor 340, which detects a rotation angle of the second MG 320. The control device 100 refers to the state of charge of the battery 250 calculated by the PCU 200.

The control device 100 calculates an engine speed NE based on the detected signal Scr of the crankshaft position sensor 52. Further, the control device 100 calculates an engine load rate KL based on the engine speed NE and the intake air amount GA. The engine load rate KL indicates the ratio of the intake air amount currently flowing into each cylinder to the intake air amount that would flow into the cylinder when the internal combustion engine 10 is stably operated under a full-load state under the current engine speed NE. The cylinder intake air amount is the amount of air flowing into each cylinder during the intake stroke.

The control device 100 calculates a required drive torque Tr required for driving the vehicle 500 based on the accelerator operation among ACCP and the vehicle speed SP. Further, in order to match the required drive torque Tr, the control device 100 controls the torque of each of the internal combustion engine 10, the first MG 310, and the second MG 320.

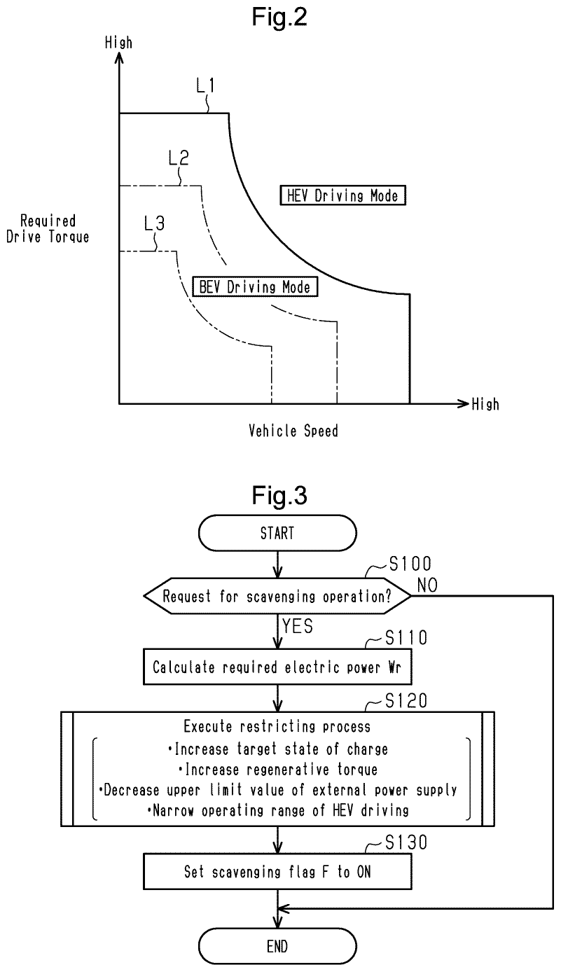

FIG. 2 shows a solid line L1 representing a borderline separating operating ranges. When an operating point indicating the required drive torque Tr and the vehicle speed SP is located at a position on or above the solid line L1, the vehicle is driven in a hybrid electric vehicle (HEV) driving mode using the torque of the internal combustion engine 10, the torque of the first MG 310, and the torque of the second MG 320.

When the operating point indicating the required drive torque Tr and the vehicle speed SP is located at a position below the borderline indicated by the solid line L1, the vehicle is driven in a battery electric vehicle (BEV) driving mode using only the motor. In other words, the BEV mode uses only the torque of the second MG 320. In the BEV mode, the operation of the internal combustion engine 10 is stopped.

The control device 100 controls regenerative torque Treg of the second MG 320 when the vehicle 500 decelerates to adjust the electric power supplied from the second MG 320 to the battery 250.

When the control device 100 performs external power supplying and supplies electric power to equipment outside the vehicle, the supply of electric power is controlled so that the electric power supplied to the outside of the vehicle from the battery 250 through the terminal 300 does not exceed an upper limit value WLM. Further, when the control device 100 performs external power supplying and the state of charge of the battery 250 becomes less than or equal to a predetermined threshold value, the internal combustion engine 10 is started, and the battery 250 is charged by the electric power generated by the first MG 310. When charging of the battery 250 is completed, the operation of the internal combustion engine 10 is stopped and charging of the battery 250 is stopped.

### Scavenging Operation

The internal combustion engine 10 is fueled by hydrogen. Thus, compared to an engine fueled by gasoline or the like, moisture derived from fuel is more likely to be produced. When the moisture wets the spark plugs of the internal combustion engine 10, the startability of the engine may be affected in an undesirable manner.

In order to avoid such a situation, the control device 100 performs a scavenging operation to remove moisture from the combustion chambers. In the scavenging operation, the internal combustion engine 10 is motored in a state in which the fuel injection is stopped. The internal combustion engine 10 is motored by driving the first MG 310 with the electric power supplied from the battery 250. The scavenging operation is performed if required as the internal combustion engine 10 stops operating when the vehicle 500 is not moving. The scavenging operation is also performed if required as the internal combustion engine 10 stops operating when the vehicle 500 is performing external power supplying.

### Restriction Process

When motoring for the scavenging operation is performed, electric power is used to drive the first MG 310. Accordingly, when the electric power stored in the battery 250, which supplies the electric power to the first MG 310, is low, there may not be enough electric power to perform scavenging sufficiently.

Therefore, the control device 100 executes a restriction process so that electric power stored in the battery 250 does not decrease.

FIG. 3 illustrates the procedures for executing the restriction process. The processes are executed in predetermined cycles by the processing circuitry 110 of the control device 100. In the description hereafter, each processing step is represented by a step number prefixed with the letter “S”.

In the series of processes illustrated in FIG. 3, the processing circuitry 110 first executes a determining process to determine whether the scavenging operation is required (S100). In S100, the processing circuitry 110 determines that the scavenging operation is required if the amount of moisture in the combustion chamber of the internal combustion engine 10 is greater than or equal to a specified threshold. The amount of moisture in the combustion chamber is calculated by the processing circuitry 110 in a separate process. For example, the processing circuitry 110 calculates the amount of moisture in the combustion chamber using physical quantities correlated with the amount of moisture and a model equation. The physical quantities correlated with the amount of moisture in the combustion chamber are, for example, the engine speed NE, the engine coolant temperature THW, the intake air temperature THA, an air-fuel ratio of the air-fuel mixture, a combustion temperature of the air-fuel mixture, the fuel injection amount, the fuel temperature, and the wall temperature of the intake manifold. The amount of moisture may be detected by a sensor.

In the process of S100, when determining that the scavenging operation is required (S100: YES), the processing circuitry 110 executes an electric power calculation process that calculates required electric power Wr (S110). The required electric power Wr is the electric power required for the scavenging operation. For example, the processing circuitry 110 calculates the required electric power Wr such that the value of the required electric power Wr increases as the calculated amount of moisture in the combustion chamber increases.

Then, the processing circuitry 110 executes the restriction process (S120). In the restriction process, electric power stored in the battery 250 is more restricted than when the restriction process is not executed.

The restriction process of the present embodiment includes steps (a) to (d).
(a): The processing circuitry 110 sets a target state of charge SOCt of the battery 250 to be higher than when the restriction process is not executed.

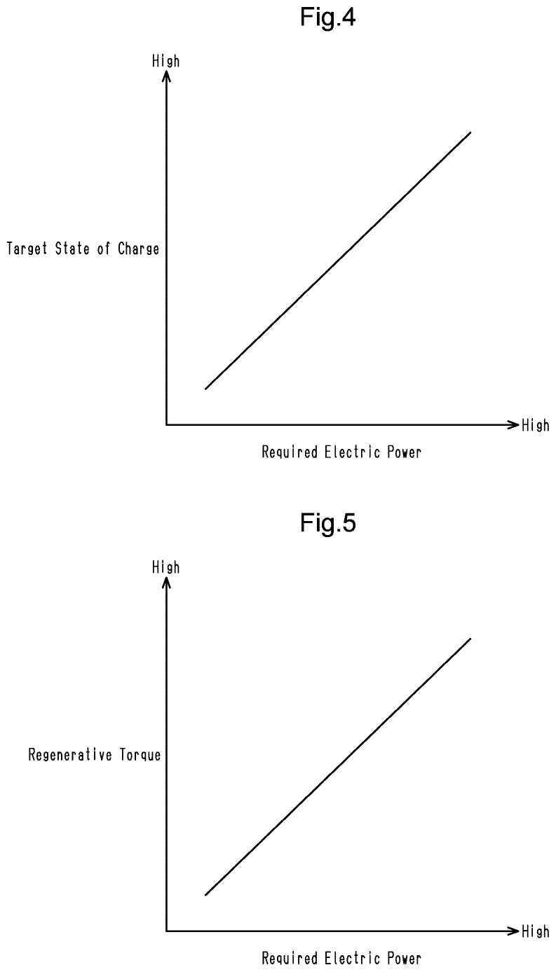

As shown in FIG. 4, the processing circuitry 110 increases the target state of charge SOCt as the required electric power Wr increases. Further, the processing circuitry 110 controls the charge amount and the discharge amount of the battery 250 so that the battery 250 meets the target state of charge SOCt.
(b): The processing circuitry 110 generates more regenerative torque Treg when the vehicle 500 decelerates than when the restriction process is not executed.

As shown in FIG. 5, the processing circuitry 110 increases the regenerative torque Treg as the required electric power Wr increases. Further, the processing circuitry 110 controls the amount of electric power generated by the second MG 320 so that regenerative torque Treg is obtained when the vehicle 500 decelerates.
(c): The processing circuitry 110 sets the upper limit WLM of the electric power supplied from the battery 250 to outside the vehicle to be lower than when the restriction process is not executed.

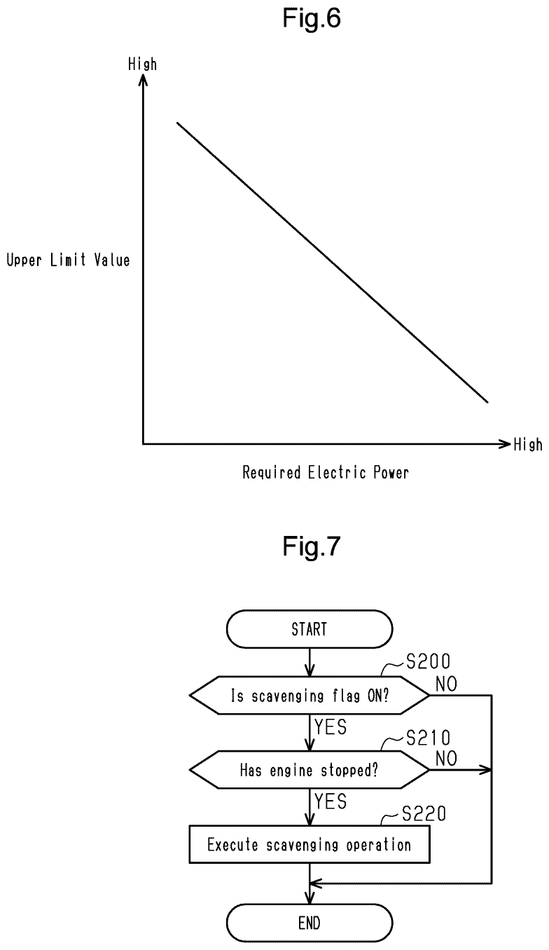

As shown in FIG. 6, the processing circuitry 110 decreases the upper limit value WLM as the required electric power Wr increases. Further, the processing circuitry 110 controls the amount of electric power supplied to the outside of the vehicle so as not to exceed the upper limit value WLM when external electric power supplying is being performed.
(d): The processing circuitry 110 sets the operating range of the vehicle 500 when driven only by the motor to be narrower than when the restriction process is not executed. In other words, the operating range in the BEV mode is set to be narrower than when the restriction process is not executed.

The single-dashed line L2 in FIG. 2 indicates the borderline of the operating ranges when the required electric power Wr is low, and the double-dashed line L3 indicates the borderline of the operating ranges when the required electric power Wr is high. As shown in FIG. 2, the processing circuitry 110 sets the operating range of the BEV driving mode, in which the vehicle is driven only by the motor, to be narrower when the required electric power Wr is high than when the required electric power Wr is low. The processing circuitry 110 switches the vehicle 500 between the HEV driving mode and the BEV driving mode in accordance with the operating range that is changed in this manner.

After executing the process of S120, the processing circuitry 110 sets a scavenging flag F to “ON” (S130).

When the process of S130 is completed or a negative determination is given in the process of S100, the processing circuitry 110 ends processing.

FIG. 7 illustrates the procedures of processes executed by the control device 100. The processes are executed by the processing circuitry 110 of the control device 100 in predetermined cycles.

In the series of processes illustrated in FIG. 7, the processing circuitry 110 determines whether the scavenging flag F is “ON” (S200).

In the process of S200, when determining that the scavenging flag is “ON”, the processing circuitry 110 determines whether the internal combustion engine 10 has stopped operating (S210). In the process of S210, an affirmative determination of the engine operation stop is given in either one of a case in which the engine stops operating when the vehicle 500 stops moving and a case in which the engine stops operating during when external power supplying is performed.

When engine operation stop is determined (S210: YES), the processing circuitry 110 executes the scavenging operation (S220). When the scavenging operation is executed, the processing circuitry 110 sets the scavenging flag F to “OFF”.

When the process of S220 is completed or a negative determination is given in the process of S200, the processing circuitry 110 ends processing.

### Operation of Present Embodiment

The vehicle 500 includes the internal combustion engine 10 fueled by hydrogen, the battery 250, and the first MG 310 configured to motor the internal combustion engine 10 with electric power supplied from the battery 250. The control device 100 of the present embodiment includes the processing circuitry 110.

The processing circuitry 110 executes the determining process (S100) that determines whether the scavenging operation is required. The scavenging operation is performed by motoring the internal combustion engine 10 in a state in which fuel injection is stopped.

Further, when the determining process determines that the scavenging operation is required, the processing circuitry 110 executes the restriction process (S120). In the restriction process, reduction in the stored electric power of the battery 250 is more restricted than when the restriction process is not executed. Accordingly, when the scavenging operation is required, the process for restricting reduction of the stored electric power of the battery 250 is executed.

### Advantages of Present Embodiment

(1) When the scavenging operation is required, the restriction process is executed to restrict reduction of the stored electric power of the battery 250. This secures the electric power required for the scavenging operation.
(2) The target state of charge SOCt of the battery 250 is increased during the restriction process. This restricts reduction of the stored electric power of the battery 250.
(3) The processing circuitry 110 executes the electric power calculation process (S110) to calculate the required power Wr, which is the electric power required for performing the scavenging operation. As shown in FIG. 4, the processing circuitry 110 increases the targe state of charge SOCt as the required electric power Wr increases. This secures the required electric power Wr.
(4) The restriction process increases the regenerative torque Treg when the vehicle 500 decelerates. When the regenerative torque Treg increases, regenerative actions enhance charging of the battery 250. This restricts reduction in the stored electric power of the battery 250.
(5) The processing circuitry 110 executes the electric power calculation process to calculate the required power Wr (S110). Furthermore, as shown in FIG. 5, the processing circuitry 110 increases the regenerative torque Treg as the required electric power Wr increases. Thus, when the required electric power Wr is high, regenerative actions enhance charging of the battery 250. This secures the required electric power Wr.
(6) The restriction process decreases the upper limit value WLM of the electric power supplied from the battery 250 to the outside of the vehicle. This restricts discharging of the battery 250 when external power supplying is being performed. Thus, reduction in the stored electric power of the battery 250 is restricted.
(7) The processing circuitry 110 executes the electric power calculation process to calculate the required power Wr (S110). As shown in FIG. 6, the processing circuitry 110 decreases the upper limit value WLM as the required electric power Wr increases. Accordingly, the upper limit value WLM is decreased as the required electric power Wr for the scavenging operation increases. This secures the required electric power Wr.
(8) The restriction process includes narrowing the operating range in which the vehicle 500 is driven only by the motor. This reduces opportunities in which the vehicle 500 is in the BEV driving mode and thus restricts discharging of the battery 250 resulting from the BEV driving mode. This restricts reduction in the stored electric power of the battery 250.
(9) The processing circuitry 110 executes the electric power calculation process to calculate the required power Wr for the scavenging operation (S110). As shown in FIG. 2, the processing circuitry 110 sets the operating range in which the vehicle 500 is driven only by the motor to be narrower when the required electric power Wr is high than when the required electric power Wr is low. This secures the required electric power Wr.

### Modifications

The above embodiments may be modified as described below. The above embodiments and the following modifications may be combined as long as the combined modifications remain technically consistent with each other.

The target state of charge SOCt is set in accordance with the required electric power Wr. However, the target state of charge SOCt may be set to be increased by a predetermined value when the restriction process is executed so as to be greater than that when the restriction process is not executed.

Regenerative torque Treg is set in accordance with the required electric power Wr. However, the regenerative torque Treg may be increased by a predetermined value when the restriction process is executed so as to be greater than that when the restriction process is not executed.

The upper limit value WLM is set in accordance with the required electric power Wr. However, the upper limit value WLM may be decreased by a predetermined value when the restriction process is executed so as to be less than when the restriction process is not executed.

The operating range in which the vehicle 500 is driven only by the motor is set in accordance with the required electric power Wr. However, the operating range of the vehicle 500 may be set be set to be narrower for a predetermined range when the restriction process is executed than when the restriction process is not executed.

The restriction process may execute only at least one of the steps (a), (b), (c), and (d). In the specification, “at least one of” should be understood to mean “one or more” of the desired options. For example, in the specification, when the number of options is two, “at least one” should be understood to mean “only one option” or “both options”. As another example, in the specification, when the number of options is three, “at least one of” should be understood to mean “only one option” or “any combination of two or more of the options”.

The vehicle 500 may include any number of motor generators.

The vehicle 500 is a series-parallel hybrid electric vehicle. However, the vehicle may be a different type of hybrid electric vehicle. For example, the vehicle 500 may be a parallel hybrid electric vehicle.

The control device 100 includes the CPU and a memory but is not limited to executing software processes. For example, the control device 100 may include one or more dedicated hardware circuits, such as application-specific integrated circuits (ASICs), which execute at least some of the software processes of the present embodiment. In other words, the control device 100 may include processing circuitry that includes any one of the following (a) to (c). (a) One or more processing devices that execute all processes described above in accordance with a program, and processing circuitry that includes one or more program storage devices such as a ROM that stores programs. (b) One or more processing devices that execute some of the processes described above in accordance with a program and one or more program storage devices, and processing circuitry that includes one or more dedicated hardware circuitry executing the remaining processes. (c) Processing circuitry that includes one or more dedicated hardware circuitry executing all of the processes described above. The program storage device, that is, a computer-readable medium includes any medium that can be used through access with a general-purpose or dedicated computer.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A control device for a hybrid electric vehicle, the hybrid electric vehicle including an internal combustion engine fueled by hydrogen, a battery, and an electric motor configured to motor the internal combustion engine with electric power supplied from the battery, comprising:
processing circuitry configured to execute
a determining process of determining whether a scavenging operation is required to motor the internal combustion engine in a state in which fuel injection to the internal combustion engine is stopped, and
a restriction process of restricting reduction of electric power stored in the battery when the determining process determines that the scavenging operation is required more than when the restriction process is not executed.

2. The control device according to claim 1, wherein the restriction process sets a target value for a state of charge of the battery to be higher than when the restriction process is not executed.

3. The control device according to claim 2, wherein
the processing circuitry is configured to execute an electric power calculation process of calculating a required electric power that is required for performing the scavenging operation, and
the processing circuitry is configured to increase the target value for the state of charge of the battery as the required electric power increases.

4. The control device according to claim 1, wherein the restriction process sets an operating range in which the hybrid electric vehicle is driven only by the motor to be narrower than when the restriction process is not executed.

5. The control device according to claim 4, wherein
the processing circuitry is configured to execute an electric power calculation process of calculating a required electric power that is required for performing the scavenging operation, and
the processing circuitry is configured to set the operating range to be narrower when the required electric power is relatively high than when the restriction process is not executed.

6. The control device according to claim 1, wherein the restriction process sets a regenerative torque of the hybrid electric vehicle when the hybrid electric vehicle decelerates to be higher than when the restriction process is not executed.

7. The control device according to claim 6, wherein
the processing circuitry is configured to execute an electric power calculation process of calculating a required electric power required for performing the scavenging operation, and
the processing circuitry is configured to increase the regenerative torque as the required electric power increases.

8. The control device according to claim 1, wherein the restriction process sets an upper limit value of electric power supplied from the battery to outside the vehicle to be lower than when the restriction process is not executed.

9. The control device according to claim 8, wherein
the processing circuitry is configured to execute an electric power calculation process of calculating a required electric power required for performing the scavenging operation, and
the processing circuitry is configured to decrease the upper limit value as the required electric power increases.

10. A method for controlling a hybrid electric vehicle, the hybrid vehicle including an internal combustion engine fueled by hydrogen, a battery, and an electric motor configured to motor the internal combustion engine with electric power supplied from the battery, comprising:
determining whether a scavenging operation is required, in which the scavenging operation motors the internal combustion engine in a state in which fuel injection to the internal combustion engine is stopped; and
when determining that the scavenging operation is required, restricting reduction of electric power stored in the battery more than when not restricting reduction of the electric power stored in the battery.
